(19) United States
(12) Patent Application Publication
(10) Pub. No.: US 2018/0063365 A1
(43) Pub. Date: Mar. 1, 2018

(54) PRINTING APPARATUS AND CONTROL METHOD OF PRINTING APPARATUS

(71) Applicant: SEIKO EPSON CORPORATION, Tokyo (JP)

(72) Inventor: Eiji KASAI, Matsumoto-shi (JP)

(73) Assignee: SEIKO EPSON CORPORATION, Tokyo (JP)

(21) Appl. No.: 15/690,789

(22) Filed: Aug. 30, 2017

(30) Foreign Application Priority Data
Aug. 31, 2016 (JP) 2016-168974

(51) Int. Cl. H04N 1/32; H04N 1/00

(52) U.S. Cl. CPC H04N 1/32117; H04N 1/0001; H04N 1/00037; H04N 2201/3253; H04N 2201/3205; H04N 2201/3208; H04N 1/00108

(57) ABSTRACT

A printing apparatus includes a printing unit that performs a printing process in accordance with print data received from at least one transmission destination; and a detection unit that detects connection information that can be used to identify the transmission destination with which the printing apparatus can communicate. A communication setting table in which multiple pieces of connection information are associated with communication setting information is stored in a storage unit of the printing apparatus. Once the detection unit detects connection information, a control unit functions as a communication setting unit that identifies communication setting information by referring to the communication setting table in accordance with the detected connection information and performs communication setting in accordance with the identified communication setting information.

### BACKGROUND

### 1. Technical Field

The present invention relates to a printing apparatus and a control method of the printing apparatus.

### 2. Related Art

A printing apparatus having communication functions that receives communication setting information for communication from another apparatus or switches communication setting information by mode switching in the apparatus has been proposed (see, for example, JP-A-2012-227787, JP-A-2008-219885, and JP-A-2003-218885).

However, the configuration of the related art requires a special function or operation mode for causing a printing apparatus to receive communication setting information from a master device that operates on a network.

### SUMMARY

An advantage of some aspects of the invention is to enable easier communication setting without requiring communication setting information to be received every time a printing apparatus is moved.

A printing apparatus according to a first aspect of the invention includes: a printing unit that performs a printing process in accordance with print data received from at least one transmission destination; a detection unit that detects connection information that can be used to identify the transmission destination with which the printing apparatus can communicate; a storage unit that stores a table in which multiple pieces of the connection information corresponding to a plurality of the transmission destinations are associated with communication setting information for communicating with the transmission destination which can be identified by using the connection information; and a communication setting unit that, once the detection unit detects the connection information, identifies the communication setting information by referring to the table in accordance with the detected connection information and performs communication setting in accordance with the identified communication setting information.

Further, it is preferable that, when the detection unit detects multiple pieces of the connection information, the communication setting unit select one of the pieces of the connection information in accordance with a predetermined condition.

Further, it is preferable that, when the detection unit detects multiple pieces of the connection information, the communication setting unit cause the printing unit to print information in accordance with a transmission destination corresponding to the selected one of the pieces of the connection information.

Further, it is preferable that the connection information include identification information of the transmission destination, and the detection unit detect the identification information of the transmission destination.

Further, it is preferable that the connection information include position information indicating a current position, and the detection unit detect the position information.

Further, it is preferable that the detection unit detect the position information by using a GPS system.

Further, it is preferable that the communication setting information include an IP address of the printing apparatus.

Further, it is preferable that a communication with the transmission destination be established by a wireless communication, and the transmission destination be an access point.

Further, according to a second aspect of the invention, a control method of a printing apparatus having a printing unit that performs a printing process in accordance with print data received from at least one transmission destination includes: at a detection unit, detecting connection information that can be used to identify the transmission destination with which the printing apparatus can communicate, and in accordance with the detected connection information, identifying communication setting information by referring to a table in which multiple pieces of the connection information corresponding to a plurality of the transmission destinations are associated with the communication setting information for communicating with the transmission destination which can be identified by using the connection information and, in accordance with the identified communication setting information, performing communication setting.

### BRIEF DESCRIPTION OF THE DRAWINGS

The invention will be described with reference to the accompanying drawings, wherein like numbers reference like elements.

FIG. 1 is a configuration diagram of a printing system including a printing apparatus according to an embodiment of the invention.

FIG. 2 is a block diagram of the printing apparatus.

FIG. 3 is a diagram illustrating an example of a communication setting table.

FIG. 4 is a flowchart illustrating the operation of the printing apparatus when performing communication setting.

FIG. 5 is a block diagram of a printing apparatus according to a modified example.

### DESCRIPTION OF EXEMPLARY EMBODIMENTS

An embodiment of the invention will be described below with reference to the drawings.

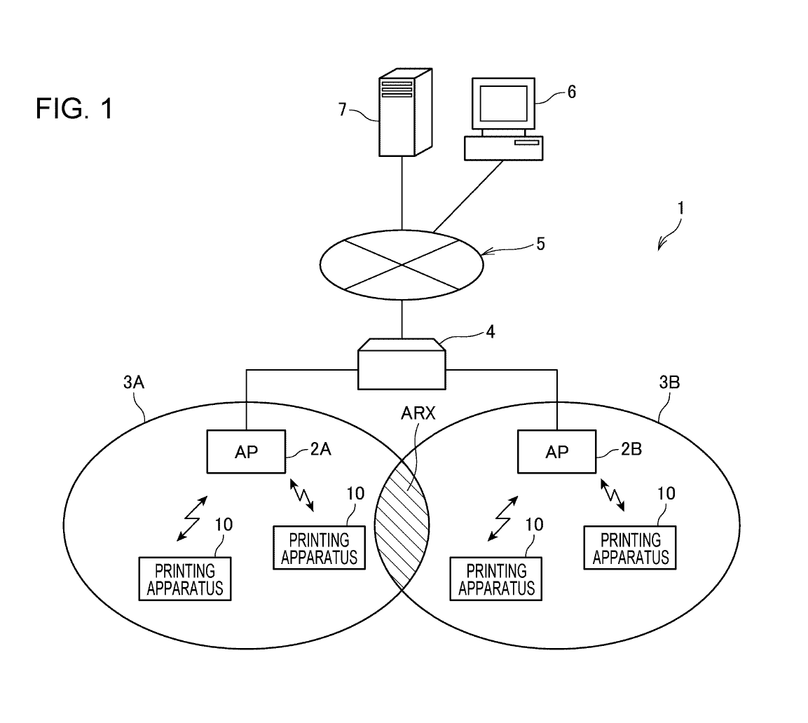

FIG. 1 is a configuration diagram of a printing system 1 including a printing apparatus 10 according to the embodiment of the invention. The printing apparatus 10 is a portable mobile printer having a wireless communication function. The printing apparatus 10 can be connected to one or both of a local area network (hereafter, referred to as a LAN) 3A and a LAN 3B by wirelessly communicating with one or both of an access point (hereafter, referred to as an AP) 2A and an AP 2B that are repeater stations.

AP 2A and AP 2B are access points provided on the LAN 3A and the LAN 3B and conform to a wireless LAN communication standard such as Wi-Fi (registered trademark) and are connected to a router 4.

Each of the AP 2A and AP 2B functions as a repeater station and a gateway for wireless communication. This enables the printing apparatus 10 to communicate with another apparatus connected to the LAN 3A or the LAN 3B via AP 2A and AP 2B, respectively, or to be connected to an external network 5 via the router 4.

In the present embodiment, although a case is described where networks to which the printing apparatus 10 can be connected are the LAN 3A and the LAN 3B, there may be other networks to which the printing apparatus 10 can be connected, in addition to the LAN 3A and the LAN 3B or instead of the LAN 3A and the LAN 3B.

The external network 5 is a communication network using Internet protocol (IP) (for example, the Internet). The external network 5 may connect a management server 6, an NTP server 7, and the like. The management server 6 is a server that manages data processed in the printing apparatus 10, which is a POS server that manages receipt information in the present configuration. Further, the NTP server 7 is a server that uses network time protocol (NTP) to synchronize the time among the communication devices connected to the external network 5. Note that the NTP server 7 may be omitted as appropriate.

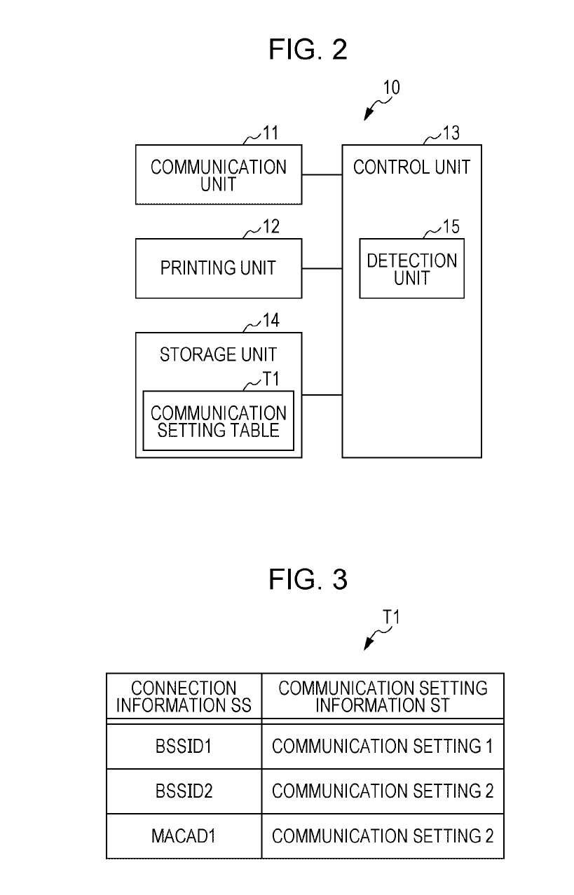

FIG. 2 is a block diagram of the printing apparatus 10.

The printing apparatus 10 has a communication unit 11, a printing unit 12, a control unit 13, and a storage unit 14. The communication unit 11 is a device that performs a communication process in which wireless communication gateways (for example, AP 2A and AP 2B) are transmission destinations. Specifically, the communication unit 11 is a device that performs a communication process by using a communication protocol according to a wireless LAN communication standard such as Wi-Fi.

The printing unit 12 has a transport mechanism that transports a roll sheet, a printing mechanism that forms dots on the roll sheet by using a printing head to print an image thereon, and a cut mechanism that cuts the roll sheet at a predetermined position. Under the control of the control unit 13, the printing unit 12 of this configuration prints an image on a roll sheet by using the printing mechanism while transporting the roll sheet by using the transport mechanism in accordance with print data for printing a receipt and cuts the roll sheet by using the transport mechanism. Thereby, the printing unit 12 performs a printing process that issues a receipt in accordance with the print data.

The control unit 13 is formed of a processor for performing calculations, such as a microcomputer, a system-on-a-chip (SOC), or a CPU, for example, and peripheral circuits. The control unit 13 controls respective units of the printing apparatus 10 by executing a control program stored in the storage unit 14.

The storage unit 14 has a non-volatile memory and stores various content such as a control program or the like. Note that a storage device other than a non-volatile memory may be used for the storage unit 14.

The printing system 1 of this configuration is required to switch communication settings of the printing apparatus 10 in accordance with the LAN 3A and the LAN 3B corresponding to transmission destinations of the printing apparatus 10.

Specifically, the LAN 3A is a network in which terminals (including the printing apparatus 10) are configured with a respective fixed ID address. For example, when no DHCP server is connected, such a fixed IP address network will be employed. Therefore, when the printing apparatus 10 is connected to the LAN 3A, it is necessary to configure the printing apparatus 10 with an available fixed IP address.

On the other hand, the LAN 3B is a network in which terminals (including the printing apparatus 10) are configure with a respective dynamic IP address by a DHCP server (not illustrated). Thus, when the printing apparatus 10 is connected to the LAN 3B, it is necessary for the DHCP server to assign an IP address, or to be manually assigned an IP address which can be used outside a range dynamically allocated by the DHCP server.

Further, the IP address used in each of the network 3A and the network 3B may be a 32-bit address in accordance with IPv4 or may be a 128-bit address in accordance with IPv6.

This configuration has a detection unit 15 that detects connection information SS that can be used to identify a transmission destination (AP 2A or AP 2B) which is able to communicate with the control unit 13, and the storage unit 14 stores therein a communication setting table T1 to be used for identifying, based on the connection information SS, communication setting information ST that is information on communication settings.

Next, the detection unit 15 and the communication setting table T1 will be described.

The detection unit 15 utilizes the communication unit 11 to detect the connection information SS. Specifically, the detection unit 15 receives, through the communication unit 11, a beacon signal such as a Wi-Fi wireless beacon transmitted from AP 2A and AP 2B, which are transmission destinations. In this case, when the printing apparatus 10 is located in a communication area of the LAN 3A, a beacon signal from AP 2A is received by the communication unit 11. Further, when the printing apparatus 10 is located in the communication area of the LAN 3B, a beacon signal from AP 2B is received by the communication unit 11.

In response to receiving a beacon signal, the detection unit 15 detects a Basic Server Set Identifier (BSSID) included in the beacon signal as the connection information SS.

Since a BSSID is information corresponding to a MAC address that can uniquely identify an AP, the BSSID corresponds to identification information of AP 2A and AP 2B and identifies AP 2A and AP 2B.

Note that the connection information SS is not limited to a BSSID.

For example, a MAC address of a service server responding to a broadcast, such as a DHCP server, may be detected as the connection information SS. For example, when connected to any of AP 2A and AP 2B, the control unit 13 of the printing apparatus 10 transmits a broadcast packet according to a predetermined communication standard. When a connection destination (a transmission destination) is AP 2B, the MAC address is transmitted from a DHCP server which has received the packet. This causes the MAC address to be received by the communication unit 11 of the printing apparatus 10 and enables the detection unit 15 to detect the MAC address. On the other hand, when a connection destination (a transmission destination) is AP 2A, since there is no DHCP server, no MAC address is transmitted.

Detecting the MAC address allows a DHCP server to be identified. Therefore, a transmission destination where the DHCP server is present can be identified (the network is LAN 3B and AP is AP 2B).

FIG. 3 illustrates an example of the communication setting table T1.

The connection information SS is information that can be used to identify a transmission destination with which the printing apparatus can communicate. FIG. 3 illustrates a case where “BSSID 1”, which is the BSSID of AP 2A, “BSSID 2”, which is the BSSID of AP 2B, and “MACAD 1”, which is the MAC address of a DHCP server on the LAN 3B, are stored as the connection information SS.

The communication setting information ST is information for communicating a transmission destination that can be identified by using the connection information SS. FIG. 3 illustrates a case where “communication setting 1”, which is the communication setting information of a network corresponding to AP 2A, and “communication setting 2”, which is the communication setting information of a network corresponding to AP 2B, are stored as the communication setting information ST.

As illustrated in FIG. 3, in the communication setting table T1, “BSSID 1” is associated with “communication setting 1”, “BSSID 2” is associated with “communication setting 2”, and “MACAD 1” is associated with “communication setting 2”. Note that, when the detection unit 15 is configured not to detect MAC addresses, that is, when the detection unit 15 is configured to detect the BSSID only, the information in which “MAC address” is associated with “communication setting 2” is unnecessary.

The “communication setting 1” is communication setting information that is necessary for the printing apparatus 10 when connected to the LAN 3A and specifically includes information of ab available fixed IP address of the LAN 3A. This IP address is a 32-bit address when the LAN 3A employs IPv4, and a 128-bit address when the LAN 3A employs IPv6.

The “communication setting 2” is communication setting information that is necessary for the printing apparatus 10 when connected to the LAN 3B. Specifically, the “communication setting 2” includes information of an available IP address of the LAN 3B, that is, an IP address which can be used outside a range dynamically allocated by the DHCP server connected to the LAN 3B. This IP address may be an address with a number of bits corresponding to whichever of IPv4 or IPv6 is employed on the LAN 3B.

Further, the “communication setting 1” and “communication setting 2” are not limited to an IP address and may include other communication setting information which is necessary for the printing apparatus 10. For example, in addition to logon information, a password, the presence or absence of encrypted communication, and the presence or absence of authentication, information necessary for a transmission destination may be included.

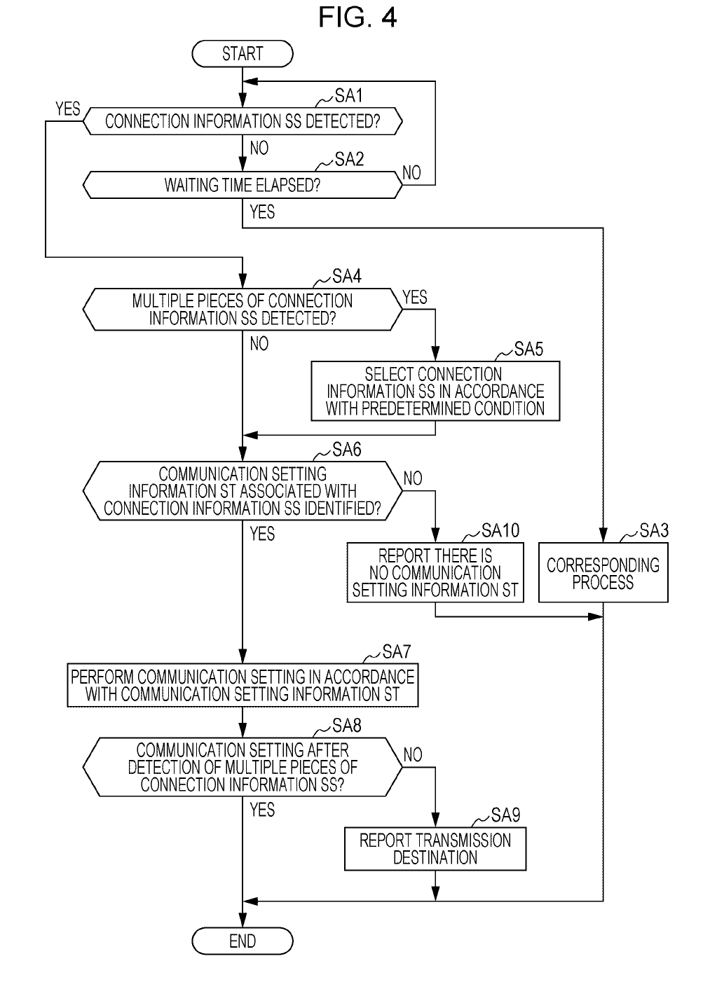

FIG. 4 is a flowchart illustrating the operation of the printing apparatus 10 when performing communication setting. The flow illustrated in FIG. 4 is executed by the control unit 13 when powered on.

First, the control unit 13 of the printing apparatus 10 performs a process of determining whether or not the connection information SS is detected (step SA1). Specifically, the control unit 13 determines whether or not the BSSID included in a beacon signal is detected by the detection unit 15 and whether or not a broadcast packet is transmitted, and then the MAC address from a DHCP server is received. Note that, when no BSSID is detected, a process for receiving the MAC address from the DHCP server may be performed.

If no connection information SS is detected (step SA1; NO), the control unit 13 repeatedly performs the determination process of step SA1 until a predetermined waiting time has elapsed (step SA2; NO). If the predetermined waiting time has elapsed (step SA2; YES), the control unit 13 performs an associated process (step SA3). The associated process is a process of reporting that no connection information SS has been detected, or a process of reporting that no communication setting is automatically made because no connection information has been detected.

The process of reporting is performed by the printing unit 12 printing predetermined information. Note that, when the printing apparatus 10 has a display unit such as a display panel or an audio output unit that outputs a sound, a process of reporting by using a display or a sound may be performed.

On the other hand, if the connection information SS is detected (step SA1; YES), the control unit 13 determines whether or not multiple pieces of connection information SS are detected (step SA4). In step SA1, a conceivable case where multiple pieces of connection information SS are detected may be a case where the printing apparatus 10 is located in an area in which the communication areas of the LAN 3A and the LAN 3B overlap each other (area ARX depicted with diagonal lines in FIG. 1). In this case, the control unit 13 enters the process of step SA5, selects the connection information SS according to a predetermined condition, and then enters the process of step SA6.

The predetermined condition may be a condition such as selection of the first detected connection information SS after being powered on, for example. This condition may be changed by a user or the like if necessary. Note that, when a predetermined condition is fixed to the condition of selection of the first detected connection information SS after being powered on, the process of step SA6 may be entered after single connection information SS is detected in step SA1. That is, the processes of steps SA4 and SA5 may be omitted.

In the process of step SA6, the control unit 13 determines whether or not the communication setting information ST associated with the connection information SS is identified by referring to the communication setting table T1 in accordance with the detected single connection information SS.

If the communication setting information ST is identified (step SA6; YES), the control unit 13 performs communication setting in accordance with the communication setting information ST (step SA7). Upon completing the communication setting, the control unit 13 causes the printing apparatus 10 to establish a communication connection with a transmission destination. The communication connection refers to a state where a logical communication path is established with respect to a transmission destination and thereafter data can be transmitted and received in accordance with a communication protocol according to a predetermined communication standard.

Subsequently, the control unit 13 determines whether or not the communication setting is the one obtained after the detection of multiple pieces of the connection information SS (step SA8). If the communication setting is not the one obtained after the detection of multiple pieces of the connection information SS (step SA8; YES), the control unit 13 ends the process regarding the communication setting.

In contrast, if the communication setting is the one obtained after the detection of multiple pieces of the connection information SS (step SA8; NO), the control unit 13 enters the process of step SA9. The process of step SA9 is a process of reporting a transmission destination and specifically instructs the printing unit 12 to print information indicating the transmission destination. Thereby, the transmission destination can be reported to the user or the like by using the printing function of the printing apparatus 10.

Thereby, for example, when the printing apparatus 10 is located in the area ARX (see FIG. 1) in which the communication areas of AP 2A and AP 2B, which are a plurality of transmission destinations, overlap each other and, when a communication connection to any of the transmission destinations is established, information indicating the transmission destination is printed. Therefore, a user can easily and quickly know which of the transmission destinations the user is connected to.

Note that, when the printing apparatus 10 has a display unit such as a display panel or an audio output unit that outputs a sound, a process of reporting by using a display or a sound may be performed in addition to the printing process or instead of the printing process.

Further, if no communication setting information ST is identified in the determination of step SA6 (step SA6; NO), the control unit 13 performs a process of reporting that there is no communication setting information ST for the automatic communication setting (step S10). That is, when no communication setting information ST is stored in the communication setting table T1, the fact that there is no suitable communication setting information ST is reported. In this case, a report that prompts the user to perform manual communication setting or the like may be produced, or a report that prompts the user to move to an appropriate area (for example, move to the areas of LAN 3A or LAN 3B) may be produced. This reporting process may be a process of producing a report by using printing or may be a process of producing a report by using a display or a sound.

Note that, by the time multiple pieces of the connection information SS have been detected in a process of step SA1, the communication setting information ST might have already been stored in accordance with other detected connection information SS, even if no communication setting information ST is identified (step SA6; NO). Thus, if no communication setting information ST is identified (step SA6; NO), a process of identifying the communication setting information ST may be performed by referring to the communication setting table T1 in accordance with the connection information SS which is different from the connection information SS selected in step SA5. Thereby, the communication setting information ST is more likely to be identified. If the communication setting information ST is identified, the process of step SA7 is entered, and if not, the process of step SA10 may be entered.

As described above, the printing apparatus 10 according to the present embodiment includes the printing unit 12, which performs a printing process in accordance with the printing data received from a transmission destination, and the detection unit 15, which detects the connection information SS that can be used to identify a transmission destination with which the printing apparatus can communicate. Furthermore, the storage unit 14 of the printing apparatus 10 stores the communication setting table T1 in which multiple pieces of the connection information SS and communication setting information ST are associated with each other. Once the detection unit 15 detects the connection information SS, the control unit 13 then functions as a communication setting unit that identifies the communication setting information ST by referring to the communication setting table T1 in accordance with the detected communication setting information ST and performs communication setting in accordance with the identified communication setting information ST. The above configuration and control method allow for an easier communication setting without requiring a function or an operation mode that receives the communication setting information ST every time the printing apparatus 10 moves.

Further, when the detection unit 15 detects multiple pieces of the connection information SS, the control unit 13 selects single connection information SS in accordance with a predetermined condition. Thereby, single connection information SS can be quickly selected when there are a plurality of transmission destinations which are able to be communicated with.

Further, when the detection unit 15 detects multiple pieces of the connection information SS, the control unit 13 performs a process of causing the printing unit 12 to print information in accordance with a transmission destination corresponding to the selected single connection information SS. Thereby, it is possible to utilize the printing function of the printing apparatus 10 to report a transmission destination under a state where multiple transmission destinations which are able to be communicated with are present.

Furthermore, the connection information SS may be the BSSID, which is identification information of AP 2A and AP 2B that are transmission destinations or the MAC address of the DHCP server supporting the transmission destination and can uniquely identify the transmission destination by such information.

The embodiment described above illustrates one aspect of the invention and can be modified and expanded in any manner within a scope of the invention.

For example, although a case where the connection information SS is the BSSID of AP 2A and AP 2B or the MAC address of a DHCP server has been described in the above embodiment, other information that can be acquired by utilizing the communication unit 11 may be applied without limited to the above. For example, the connection information SS may include an IP address, a MAC address, or the like which indicates a transmission destination. That is, the connection information SS may include a BSSID, an IP address, and a MAC address, if necessary, which are identification information of a transmission destination and, though not the identification information of a transmission destination, may include a MAC address or the like of a DHCP server which can identify the transmission destination.

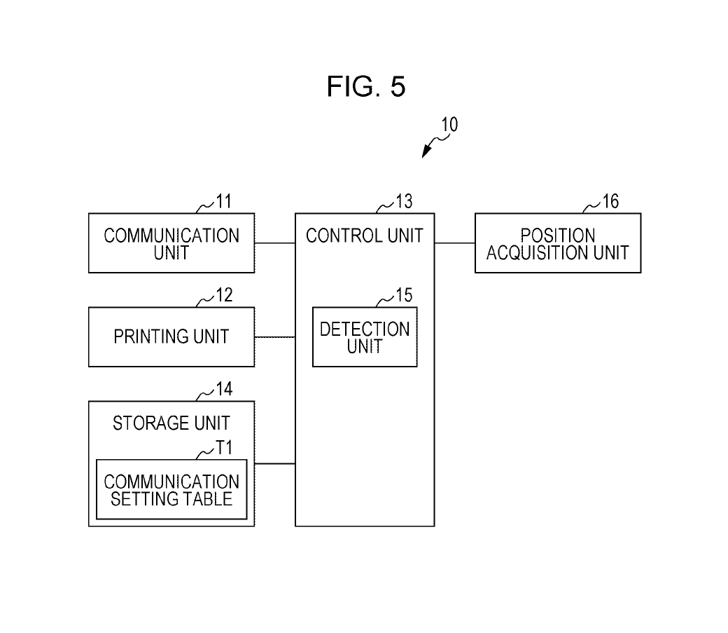

Furthermore, the connection information SS is not limited to the information that can be acquired by utilizing the connection unit 11. FIG. 5 illustrates a block diagram of the printing apparatus 10 according to a modified example. The printing apparatus 10 has a position acquisition unit 16 that acquires position information indicating the current position. Further, the detection unit 15 detects the position information acquired by the position acquisition unit 16 as the connection information SS that can be used to identify a transmission destination.

The position acquisition unit 16 is a GPS unit or an iBeacon (registered trademark) receiving device that acquires position information by utilizing a GPS system, for example. In the case of the GPS unit, the detection unit 15 controls the GPS unit to acquire the current position when powered on and detects the acquired current position as the connection information SS.

The iBeacon receiving device is a device that can receive push-type information including information which can identify a position from a predetermined external device. In the case of the iBeacon receiving device, the detection unit 15 controls the iBeacon receiving device to receive push-type information and detects information which can identify a position included in the received information (corresponding to position information) as the connection information SS.

That is, in accordance with position information indicating the current position, the printing apparatus 10 can identify which communication area of transmission destination, AP 2A or AP 2B, the printing apparatus 10 is located. By utilizing this and pre-storing the connection information SS, which is position information, and the communication setting information ST in association with each other, it is possible to obtain suitable communication setting information ST in accordance with the position of the printing apparatus 10 and easily perform communication setting.

Further, although the case where the invention is applied to the printing apparatus 10 having a wireless communication function has been described in the above embodiment, the invention may be applied to the printing apparatus 10 having a wired communication function.

Further, each block illustrated in the drawings may be implemented in any way with cooperation of hardware and software, and does not intend to suggest a particular hardware configuration.

What is claimed is:

1. A printing apparatus comprising:
a processor that performs a printing process in accordance with print data received from at least one transmission destination;
a digital detector that detects connection information that can be used to identify the transmission destination with which the printing apparatus can communicate;
a storage that stores a table in which multiple pieces of the connection information corresponding to a plurality of the transmission destinations are associated with communication setting information for communicating with the transmission destination which can be identified by using the connection information; and
a communication setting assembly that, once the digital detector detects the connection information, identifies the communication setting information by referring to the table in accordance with the detected connection information and performs communication setting in accordance with the identified communication setting information.

2. The printing apparatus according to claim 1, wherein, when the digital detector detects multiple pieces of the connection information, the communication setting assembly selects one of the pieces of the connection information in accordance with a predetermined condition.

3. The printing apparatus according to claim 2, wherein, when the digital detector detects multiple pieces of the connection information, the communication setting assembly causes the processor to print information in accordance with a transmission destination corresponding to the selected one of the pieces of the connection information.

4. The printing apparatus according to claim 1,
wherein the connection information includes identification information of the transmission destination, and
wherein the digital detector detects the identification information of the transmission destination.

5. The printing apparatus according to claim 1,
wherein the connection information includes position information indicating a current position, and
wherein the digital detector detects the position information.

6. The printing apparatus according to claim 5, wherein the digital detector detects the position information by using a GPS system.

7. The printing apparatus according to claim 1, wherein the communication setting information includes an IP address of the printing apparatus.

8. The printing apparatus according to claim 1,
wherein a communication with the transmission destination is established by a wireless communication, and
wherein the transmission destination is an access point.

9. A control method of a printing apparatus having a processor that performs a printing process in accordance with print data received from at least one transmission destination, the method comprising:
at a digital detector, detecting connection information that can be used to identify the transmission destination with which the printing apparatus can communicate, and
in accordance with the detected connection information, identifying communication setting information by referring to a table in which multiple pieces of the connection information corresponding to a plurality of the transmission destinations are associated with the communication setting information for communicating with the transmission destination which can be identified by using the connection information and, in accordance with the identified communication setting information, performing communication setting.
